(19) United States
(12) Patent Application Publication
(10) Pub. No.: US 2009/0044964 A1
(43) Pub. Date: Feb. 19, 2009

(54) Utility Outlets as a Security System

(75) Inventor: Roland Schoettle, Freeport GBI (BS)

Correspondence Address: FULBRIGHT & JAWORSKI L.L.P, 2200 ROSS AVENUE, SUITE 2800, DALLAS, TX, 75201-2784, US

(73) Assignee: Optimal Innovations Inc., Bridgetown (BB)

(21) Appl. No.: 12/171,135

(22) Filed: Jul. 10, 2008

Related U.S. Application Data
(60) Provisional application No. 60/956,314, filed on Aug. 16, 2007.

(51) Int. Cl. H01H 13/04; G08B 1/08; G08B 13/22

(52) U.S. Cl. 174/55; 340/541; 340/538

(57) ABSTRACT

Utility outlets that function as a security system in a premises is disclosed. Utility outlets that function as a security system reduces the number of devices that need to be installed in a premises, thereby by reducing overall costs in installing a security system. Additionally, using utility outlets as a security system allows the security system to encompass the movement of electrical devices or the operation of electrical devices as security breach conditions.

### CROSS-REFERENCE TO RELATED APPLICATIONS

This application claims priority from U.S. Provisional Patent Application No. 60/956,314, entitled “UTILITY OUTLETS AS A SECURITY SYSTEM” and filed Aug. 16, 2007, the disclosure of which is hereby incorporated herein by reference. The present application is related to co-pending, and commonly assigned U.S. patent application Ser. No. 10/094,743, Attorney Docket No. 74268/P005US/10506911, entitled “HYBRID FIBER/CONDUCTOR INTEGRATED COMMUNICATION NETWORKS;” U.S. patent application Ser. No. 11/512,742, Attorney Docket No. 74268/P008US/10606747, entitled “HYBRID FIBER/CONDUCTOR INTEGRATED COMMUNICATION NETWORKS;” U.S. patent application Ser. No. 11/683,304, Attorney Docket No. 74268/P012US/10609934, entitled “SYSTEMS AND METHODS FOR LINKING UTILITY CONTROL DEVICES;” U.S. patent application Ser. No. 11/683,327, Attorney Docket No. 74268/P013US/10609935, entitled “SYSTEM AND METHOD FOR INFRASTRUCTURE REPORTING;” U.S. patent application Ser. No. 11/683,298, Attorney Docket No. 74268/P014US/10614006, entitled “LIGHT SWITCH USED AS A COMMUNICATION DEVICE;” U.S. patent application Ser. No. 11/683,308, Attorney Docket No. 74268/P015US/10614005, entitled “SYSTEM AND METHOD FOR PREMISES MONITORING USING WEIGHT DETECTION;” U.S. patent application Ser. No. 11/923,176, Attorney Docket No. 74268/P015CP1/10704955, entitled “SELF LEARNING AUTOMATION SYSTEM;” U.S. patent application Ser. No. 11/683,326, Attorney Docket No. 74268/P016US/10614296, entitled “ANTICIPATORY UTILITY CONTROL DEVICE;” U.S. patent application Ser. No. ______, Attorney Docket No. 74268/P016CP1/10704956, entitled “ANOMALY-BASED PREMISE CONTROL;” U.S. patent application Ser. No. 11/683,335, Attorney Docket No. 74268/P017US/10614295, entitled “PLUG AND PLAY UTILITY CONTROL MODULES;” U.S. Patent Application No. 60/956,279, Attorney Docket No. 74268/V022.0/10712693, entitled “UTILITY OUTLETS CAPABLE OF PRESENTING IMAGES;” U.S. patent application Ser. No. 11/683,354, Attorney Docket No. 74268/P025US/10704959, entitled “LIGHT SWITCH POWER SUPPLY;” U.S. Patent Application No. 60/956,314, Attorney Docket No. 74268/V026.0/10712694, entitled “UTILITY OUTLETS AS A SECURITY SYSTEM;” U.S. Patent Application No. 60/940,010, Attorney Docket No. 74268/V027.0/10706725, entitled “LIGHT SWITCH AS A SECURITY HUB;” U.S. Patent Application No. 60/940,015, Attorney Docket No. 74268/V028.0/10706810, entitled “UTILITY OUTLETS AS REMOTE CONTROL REPEATERS;” U.S. patent application Ser. No. ______, Attorney Docket No. 74268/P029US/10704963, entitled “TEMPERATURE DETECTIONS AND CALCULATIONS OUTLETS,” the disclosures of which are hereby incorporated herein by reference.

### TECHNICAL FIELD

The current invention relates to utility outlets and specifically the use of utility outlets in a security system.

### BACKGROUND OF THE INVENTION

Security systems are commonplace in commercial and residential premises. A security system typically includes a central processing control unit connected to several sensors around a premises. The sensors may be contact sensors installed at windows or doors or sensors that can detect motion. Retrofitting an existing building with a security system can be expensive if the new system is to be hard wired because it usually involves the alteration of existing structures such as walls. Consequently, there is a need for products and methods that allow the retrofitting of an existing building with minimal alteration to the building's structure. With regard to security systems for new construction, there is potential for reducing the number of devices that need to be installed in a premises.

### BRIEF SUMMARY OF THE INVENTION

The present invention is directed to the use of utility outlets in a security system. Utility outlets are pervasive in modern premises. Because most security systems require sensors to be located throughout a premises to detect security breaches and utility outlets are pervasive in most premises, it is advantageous to make utility outlets capable of detecting security breaches. The current invention uses utility outlets such as light switches, power sockets and permanently mounted light sockets to replace stand-alone security sensors. Because the utility outlets of the present invention have multiple functions, the use of these outlets would reduce the number of devices that need to be installed in a premises. Additionally, the use of utility outlets as security devices provides an opportune means of transmitting security related signals via electrical wiring of the premises. Transmission via the electrical wiring of the premises avoids the need for installing a separate wiring system solely for security purposes. This is particularly important in retrofitting an existing building with a security system. Further, the electrical wiring of the premises also supplies the utility outlet with the power required to operate the security system.

An additional benefit of using utility outlets as a security system is that the utility outlet, if desired, may be made to detect changes in the connectivity status of electrical devices in relation to the utility outlet or the premises' electrical supply. The connectivity status of a device to a utility outlet refers to whether the device is connected or not to the utility outlet. In the case of a power socket, this would mean whether the device is plugged into the power socket or not. Connectivity status of a device, such as a light bulb, to the premises' electrical supply would mean whether the light bulb is on or off.

When a change in connectivity status of a device to the utility outlet or power supply is unexpected, it may serve as an indicator of a security breach. For example, if a burglar unplugs a television set in a home, a contact sensor or other sensor in the utility outlet may detect this change. Further, a burglar who has turned a light switch on has connected the light to the electrical power and, if unexpected, this indicates a security breach. Accordingly, utility outlets provide an inconspicuous means of detecting a security breach by monitoring electrical devices' connectivity to the utility outlets or premises' power supply.

Additionally, the detection of a breach based on the connectivity status of devices to utility outlets or power supply provides a “second tier” detection of a security breach where the detection of unauthorized entry to a premises is considered “first tier.” For example, an entity may not want a security system that detects unauthorized entry because the premises is open to the public continuously. However, that entity may consider it a security breach if certain devices are moved from a utility outlet or operated during certain periods. Accordingly, the current invention provides a way of detecting security breaches at a level typically not monitored by security systems—that is, security breaches that do not involve unauthorized entry within the premises.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a light switch as one embodiment of the current invention.

FIG. 2 shows a system using utility outlets in a security system as one embodiment of the current invention.

### DETAILED DESCRIPTION OF THE INVENTION

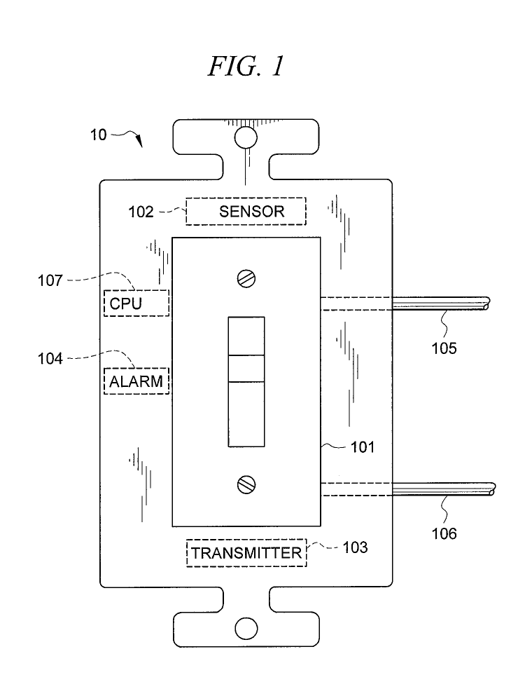

FIG. 1 shows a light switch as one embodiment of the current invention. Light switch 10 includes an actuator 101, a sensor 102 and a transmitter 103. Actuator 101 switches a device on or off a premises' electrical power. Sensor 102 is capable of detecting a security breach condition. A potential security breach condition is a condition that the security system detects and analyses to determine if in fact there has been a security breach. Sensor 102 may be a motion sensor that involves the use of any of the following: infrared light, high frequency sound emission and microwave signal emission. When sensor 102 detects motion, for example, transmitter 103 sends a signal to central processing unit (CPU) 107. It should be noted that CPU 107 may be located in the utility outlet 10 but may also be located outside of and remote from the utility outlet 10. CPU 107 determines whether the motion detected (the potential security breach) is a security breach based on preprogramming by a user, i.e. whether the user ‘armed’ the security system. If CPU 107 determines there is a security breach, CPU 107 sends a signal to an alarm device 104, causing device 104 to alarm. Alarm device 104 may be located within utility outlets 10 or may be outside of and remote from utility outlets 10. Alarm device 104 may be a microphone or an illuminating device that emits a squealing sound or a flashing light, respectively. Power cable 105 is a conduit for the premises' power supply and is connected to utility outlet 10 by a terminal (not shown). Transmitter 103 may transmit signals via power cable 105, communication cable 106, or wirelessly.

Utility outlet 10, if desired, may also include sensors that detect changes to the connectivity status of a device with the utility outlet 10 or electrical power. When a device is unplugged from a power socket or when a light switch has been turned on or off, the utility outlet detects this and sends a signal to CPU 107. Here, the invention takes advantage of the fact that in some scenarios the removal of electrical equipment from the premises and/or the operation of electrical devices on the premises, such as lights, garage openers etc. indicate a security breach.

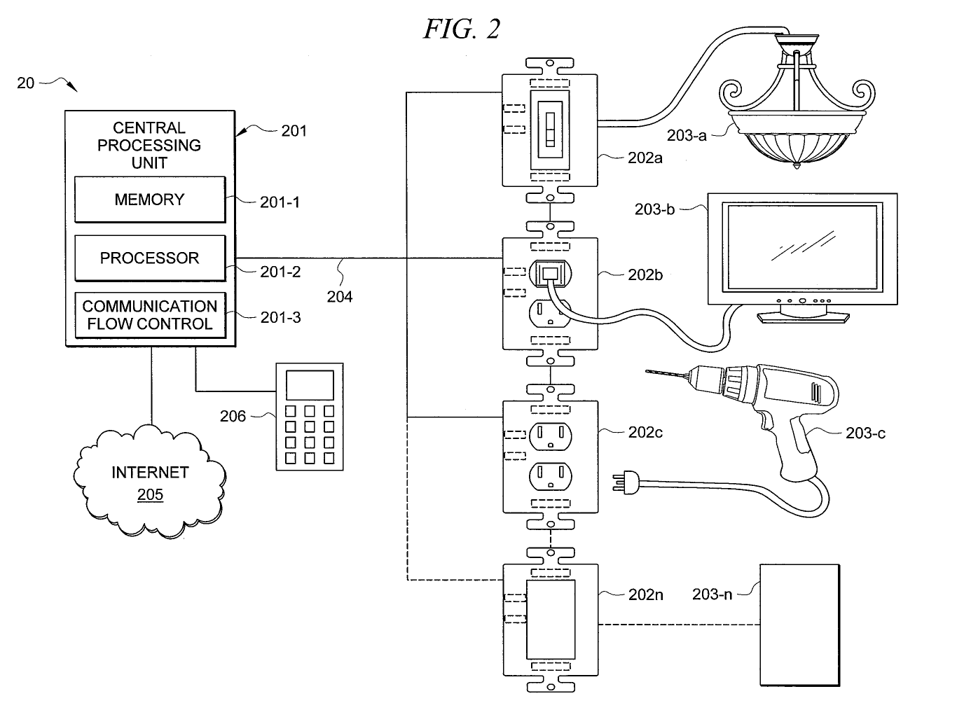

FIG. 2 shows a system using utility outlets in a security system as one embodiment of the current invention. The system includes a central processing unit (CPU) 201. CPU 201 could be a personal computer, a control panel, or a processor located in some other device including one of the utility outlets. CPU 201 includes a memory 201-1, a processor 201-2 and communication flow control 201-3. CPU 201 is communicably connected to utility outlets 202a-202n via power line network 204. Utility outlets 202a-202n are capable of connecting devices 203-a-203-n to the premises' electrical power. A user, through an input device 206, can “arm” the security system.

Light switches are typically located close to the entrance of a room. Consequently, a light switch is ideally positioned to detect a security breach such as unauthorized entry into a premises. Light switch 202a, for example, may be located near a door in a premises. When light switch 202a detects motion, light switch 202a sends a signal to CPU 201. If the system has been armed by a user, signals from a utility outlet will be processed by CPU 201, which then sends a signal to another device such as a siren or a strobe light to cause an alarm. In some embodiments, the utility outlets 202a-202-n are equipped to emit a sound or to illuminate to create the alarm. In the latter scenario, CPU 201 would send a signal, to some or all the devices in the premises, that causes the utility outlets to alarm.

Considering further examples, illustrated is power socket 202b which has a plug for a television 203-b plugged into power socket 202b. If someone disconnects television 203-b's plug from power socket 202b, power socket 202b would send a signal to CPU 201. CPU 201 would determine if this signal indicates a security breach. If the signal does indicate a security breach, then CPU 201 would send a signal to another device to create an alarm.

Similarly, if hand drill 203-c is plugged into power socket 202c, power socket 202c would send a signal to CPU 201. As described above, CPU 201 would process the signal and initiate the creation of an alarm if necessary. The communications between the CPU 201 and the utility outlets may be via cable network 204. Cable network 204 may be a power cable network in the premises or other cable network within the premises. However, in some embodiments, communication by cable may be replaced or supplemented by wireless communication. It should be noted that CPU 201, if desired, may be connected to an electronic network such as Internet 205 for sending a signal to a remote device.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A utility outlet for use in connecting to a premises electrical power, said utility outlet comprising:
means for connecting electrical devices to said premises' electrical power; and
means for detecting a potential security breach condition in said premises.

2. The utility outlet of claim 1 wherein said utility outlet is one of the group consisting of:
a power socket, an electrical switch, a permanently mounted light socket.

3. The utility outlet of claim 1 further comprising:
means for sending a signal, wherein said means for sending is communicably connected to said means for detecting.

4. The utility outlet of claim 3 further comprising:
a central processing unit communicably connected to said means for sending a signal, said central processing unit capable of determining whether said detected condition is a security breach and sending a signal in response to said security breach.

5. The utility outlet of claim 4 further comprising:
means for creating an alarm, wherein said means for creating an alarm is communicably connected to said central processing unit.

6. The utility outlet of claim 3 configured to be communicably connected to a central processing unit remote from said utility outlet, wherein said central processing unit is capable of determining whether said detected condition is a security breach and further capable of sending a signal in response to said security breach.

7. The utility outlet of claim 6 further comprising:
means for creating an alarm, wherein said means for creating an alarm is communicably connected to said central processing unit.

8. The utility outlet of claim 1 wherein said means for detecting is a motion sensor.

9. The utility outlet of claim 1 wherein said means for detecting includes means for detecting a change in connectivity of at least one of said electrical devices with at least one of the group consisting of:
said utility outlet, said premises' electrical power.

10. A method of securing a premises using utility outlets, said method comprising:
connecting electrical devices to said premises' electrical power through said utility outlets; and
detecting a potential security breach condition in said premises by at least one of said utility outlets located within said premises.

11. The method of claim 10 wherein said utility outlets are selected from the group consisting of:
a power socket, an electrical switch, a permanently mounted light socket.

12. The method of claim 10 further comprising:
sending a signal to a central processing unit in response to said detection of said potential security breach condition.

13. The method of claim 12 wherein said central processing unit is located in one of said utility outlets.

14. The method of claim 12 further comprising:
determining whether said detected potential security breach condition is a security breach and sending a security breach signal in response to said determined security breach.

15. The method of claim 14 further comprising:
creating an alarm in response to said security breach signal.

16. The method of claim 10 wherein said detecting is done by a motion sensor.

17. The method of claim 10 wherein said detecting includes identifying a change in connectivity of at least one of said devices with at least one of the group consisting of:
said utility outlet, said premises' electrical power.

18. A utility outlet for use in connecting to a premises' electrical power, said utility outlet comprising:
a terminal for connecting electrical devices to said premises' electrical power; and
a sensor for detecting a potential security breach condition.

19. The utility outlet of claim 18 wherein said utility outlet is one of the group consisting of:
a power socket, an electrical switch, a permanently mounted light socket.

20. The utility outlet of claim 18 further comprising:
a transmitter.

21. The utility outlet of claim 20 wherein said transmitter is capable of transmitting wirelessly.

22. The utility outlet of claim 20 further comprising:
a central processing unit communicably connected to said transmitter, wherein said central processing unit is capable of determining whether said detected potential security breach condition is a security breach and sending a signal in response to said determined security breach.

23. The utility outlet of claim 22 further comprising:
an alarm device communicably connected to said central processing unit.

24. The utility outlet of claim 20 wherein said transmitter is configured to be communicably connected to a central processing unit remote from said utility outlet, wherein said central processing unit is capable of determining whether said potential security breach condition is a security breach and further capable of sending a signal in response to said security breach.

25. The utility outlet of claim 24 further comprising:
an alarm device communicably connected to said central processing unit.

26. The utility outlet of claim 25 wherein said alarm is selected from the group consisting of:
an illuminating device and an audio device.

27. The utility outlet of claim 18 wherein said sensor is a motion sensor.

28. The utility outlet of claim 18 wherein said sensor is a contact sensor for detecting a change in connectivity of at least one of said electrical devices with said utility outlet.

29. The utility outlet of claim 18 wherein said sensor detects the flow of current to at least one of said electrical devices.
